(19) United States
(12) Patent Application Publication
(10) Pub. No.: US 2003/0142422 A1
(43) Pub. Date: Jul. 31, 2003

(54) Vibration-dampened mirror/speaker system for motorcycles

(76) Inventors: Jamie P. Spitzer, Green Bay, WI (US); Rodney F. Malfroid, New Franken, WI (US)

Correspondence Address: JANSSON, SHUPE & MUNGER, LTD, 245 MAIN STREET, RACINE, WI, 53403, US

(21) Appl. No.: 10/066,482

(22) Filed: Jan. 31, 2002

(51) Int. Cl. G02B 5/08; G02B 7/18

(52) U.S. Cl. 359/842

(57) ABSTRACT

The invention involves a mirror-speaker combination for mounting on a motorcycle. The mirror-speaker combination is comprised of an aft portion and a fore portion. The fore portion is releasably sealed with respect to the aft portion thereby presenting a housing. The aft portion has a concave interior surface. The fore portion has an exterior surface with a mirror-receiving section suitable to accommodate a mirror and with a sound-releasing section with at least one sound-releasing aperture therethrough. The fore portion also has an interior surface. A mirror is attached with respect to the exterior surface of the fore portion whereby a motorcycle operator is able to view objects behind him or her while on the motorcycle. A speaker is attached with respect to the interior surface of the fore portion whereby sound produced by the speaker may exit the housing through the at least one sound-releasing aperture. The combination also has a mounting assembly attached with respect to the housing whereby the mirror-speaker combination may be attached with respect to a handlebar of the motorcycle.

### FIELD OF THE INVENTION

This invention is related generally to speakers covering and, more particularly, to speakers affixed to motorcycles.

### BACKGROUND OF THE INVENTION

Radios and motor vehicles have a long-standing tradition together. It is desirable on any excursion, and especially desirable on trips of longer distance, to have the aural diversion of music or other information. This is equally true for motorcycles.

For a variety of reasons, audio systems have not been widely used on motorcycles. Among others, these reasons include the lack of space for a signal generator and speakers on the motorcycle, the lack of security for the components of an audio system, the detraction of the look of the motorcycle, and the loss of sound quality due to wind speed from a console-mounted unit. When speakers are mounted, they are placed on the body of the motorcycle in a central location, thereby defeating the stereo-sound produced by most modern signal generators.

By the term “signal generator” herein, applicants are referring to the source of an electronic or electric signals, which are transmitted to a speaker for the production of sound waves for sensing by a person. Examples of signal generators include, but are not limited to, radio receivers, compact disk players, cassette tape players, and computers with sound cards.

To avoid the problems above for console-mounted speakers, some riders use a personal receiver mounted to head gear in the form of headphones, ear plugs, or helmet mounts. Such headgear-mounted speakers are not desirable for they obscure hazard or warning signals from other drivers or other emergency vehicles. For this reason, some jurisdictions prohibit the use of such personal audio systems by motorcyclists.

The device of U.S. Pat. No. 4,445,228 (Bruni) was an attempt to address the problem by placing speakers in a housing with the mirror. The Bruni device encountered severe vibration causing shaking of the unit relative to the motorcycle and shaking of components within the unit. The first serious problem experienced by an operator due to the vibration of the Bruni unit was the lack of visibility in the mirror. The vibration also caused loosening of the support at the handlebar and at the housing necessitating regular and frequent on-road adjustment, which further created inordinate wear resulting in quicker vibrational loosening. The three-piece housing design exacerbated the negative effects of the vibration.

The three-piece housing not only exacerbated the vibration effect, but provided more avenues for water infiltration, which causes component failure. Having a cardboard speaker, the Bruni device was particularly susceptible to poor longevity when subjected to water within its housing.

Moreover, due to the three-piece housing design, the repair of any loose components caused by the vibration or any other repair necessary within the housing, required disassembly of the entire unit. Separate from the instances of repair of internal components, due to placement of the linking mechanism within the housing, removal of the unit for repair or replacement of the housing required disassembly of the entire unit, as well.

The Bruni device placed its audio unit in a position over the gas tank, simultaneously obscuring the vision of the operator of the motorcycle instrument panel, while placing an electrical element subject to potential shorting, over the gas tank. As a result of the position, the unit had to be moved out of place at each refueling. It obviousness also made the unit a target of theft.

A vibration-dampened mirror/speaker system would be an important improvement in the art.

### OBJECTS OF THE INVENTION

It is an object of the invention to provide a stereo speaker system for use with motorcycles.

It is another object of the invention to provide vibration-dampened mirror/speaker system that resists loosening that otherwise occurs due to vibration in the operation of motorcycles in accessories attached to the motorcycles.

Still another object of the invention is to provide a mirror/speaker housing that is imperious to water infiltration.

Yet another object of the invention is to provide a mirror/speaker housing that is easy to access interior space.

It is another object of the invention to provide a mirror/speaker system which can have components within repaired without disassembly of the entire unit.

It is another object of the invention to provide vibration-dampened mirror/speaker system that results in a more secure attachment to the handlebars of a motorcycle.

It is yet another object of this invention to provide a mirror/speaker system which can be removed from its mount without disassembly of the unit.

How these and other objects are accomplished will become apparent from the following descriptions and from the drawings.

### SUMMARY OF THE INVENTION

The invention involves a mirror-speaker combination for mounting on a motorcycle. The mirror-speaker combination is comprised of an aft portion and a fore portion. The fore portion is releasably sealed with respect to the aft portion thereby presenting a housing. The aft portion has a concave interior surface. The fore portion has an exterior surface with a mirror-receiving section suitable to accommodate a mirror and with a sound-releasing section with at least one sound-releasing aperture therethrough. The fore portion also has an interior surface. A mirror is attached with respect to the exterior surface of the fore portion whereby a motorcycle operator is able to view objects behind him or her while on the motorcycle. A speaker is attached with respect to the interior surface of the fore portion whereby sound produced by the speaker may exit the housing through the at least one sound-releasing aperture. The combination also has a mounting assembly attached with respect to the housing whereby the mirror-speaker combination may be attached with respect to a handlebar of the motorcycle.

In one embodiment of the invention, the mirror-speaker combination further has a sealing element placed between the fore portion and the aft portion of the housing when the portions are attached, thereby making the housing watertight. It is preferable that the sealing element is of a porous polytetrafluoroethylene (PTFE).

In another embodiment of the invention, the mirror-speaker combination of has a signal source attached to the motorcycle remote from the housing. The signal source can be, by way of illustration only, a radio receiver, an audio cassette, an audio compact-disc player, or a personal computer. The signal source electrically transmits the signal along a wire or wires extending from the signal source to the speaker, the wire or wires entering the housing through a port.

In this embodiment, it is more preferable the mounting assembly includes a wire-transmitting conduit. The mounting assembly has a distal end attached to the housing and a proximal end for mounting to the motorcycle, and further includes a first opening at the distal end and a second opening dispensed relative to the proximal end. The distal end of the mounting assembly is attached to the housing at the port whereby the wires enter the port of the housing through the conduit.

In another embodiment, the at least one sound-releasing aperture is configured and arranged to deflect rainwater away from the speaker. One such suitable configuration provides a downward slope to the aperture from the interior to the exterior of the housing.

In yet another embodiment, the aft portion of the mirror-speaker combination has at least one light-emitting element, configured and arranged to be visible downrange when the motorcycle is in operation. It is even more preferred that the at least one light-emitting element is selectively employable by a motorcycle operator to provide a visual indicator signal to oncoming traffic as to the motorcycle operator's operational intent.

In another embodiment of the invention, it is preferable that the mounting assembly is comprised of a substantially spherical upper-portion joint end; and is comprised of a substantially cylindrical lower portion having a connecting end suitable for releasable attachment to the motorcycle handlebars.

It is another aspect of this invention to provide an audio system for motorcycles, a mirror/speaker system, which is comprised of a mirror/speaker housing with a substantially vertical fore member removably attached to an aft member, and both a speaker and a mirror supported by said fore member. The housing is mounted on a handlebar of the motorcycle by a mounting assembly. The audio system further has a power amplifier and an audio-selection unit attached with respect to the motorcycle remote from the housing. The audio-selection unit is connected through the power amplifier to the speaker. The fore member includes the speaker supported by the fore member in a position within the housing. The fore member contains at least one aperture in a speaker-receiving section of the fore member adjacent to the speaker. The mirror is mounted to an exterior surface of said fore member on a mirror-receiving section, such that the mirror does not impinge on the at least one aperture.

It is preferred to have a sealing element between the fore member and the aft member. This will keep water and dirt out of the housing while damping vibration between the parts of the housing.

It is preferable to have two mirror/speaker assemblies mounted on handlebars, one on each side of the motorcycle. In this way, for a properly configured receiver, the motorcycle operator may experience true stereo sound.

### BRIEF DESCRIPTION OF THE DRAWINGS

The drawings illustrate preferred embodiments which include the above-noted characteristics and features of the invention. The invention will be readily understood from the descriptions and drawings. In the drawings:

FIG. 1 is a perspective drawing of two of the devices mounted on the left and right sides of the handlebars of a motorcycle.

FIG. 2 is an enlarged view of the devices attached to the handlebars of the motorcycle.

FIG. 3 is a front view of the mirror/speaker system.

FIG. 4 is a cross-sectional side view of the mirror/speaker system taken along the line 4-4 of FIG. 3.

FIG. 5 is a side cross-sectional view of the fore portion of the mirror/speaker system taken along the line 5-5 of FIG. 3.

FIG. 6 is an exploded view of the mirror/speaker system.

FIG. 7 is a side view of a left-side mounting support.

FIG. 8 is a bottom view of a left-side mounting support.

FIG. 9 is a side view of a right-side mounting support.

FIG. 10 is a side view of a right-side mounting support.

FIG. 11 is a side view of an alternate right-side mounting support.

FIG. 12 is a top view of a pivot ball.

FIG. 13 is a side view of the pivot ball of FIG. 12.

FIG. 14 is a side view of a one-piece retention collar.

FIG. 15 is a bottom view of the one-piece retention collar of FIG. 14.

FIG. 16 is a front view of an alternate mirror/speaker system with information graphics.

FIG. 17 is a back view of an alternate mirror/speaker system with visual signals.

### DETAILED DESCRIPTION OF PREFERRED EMBODIMENTS

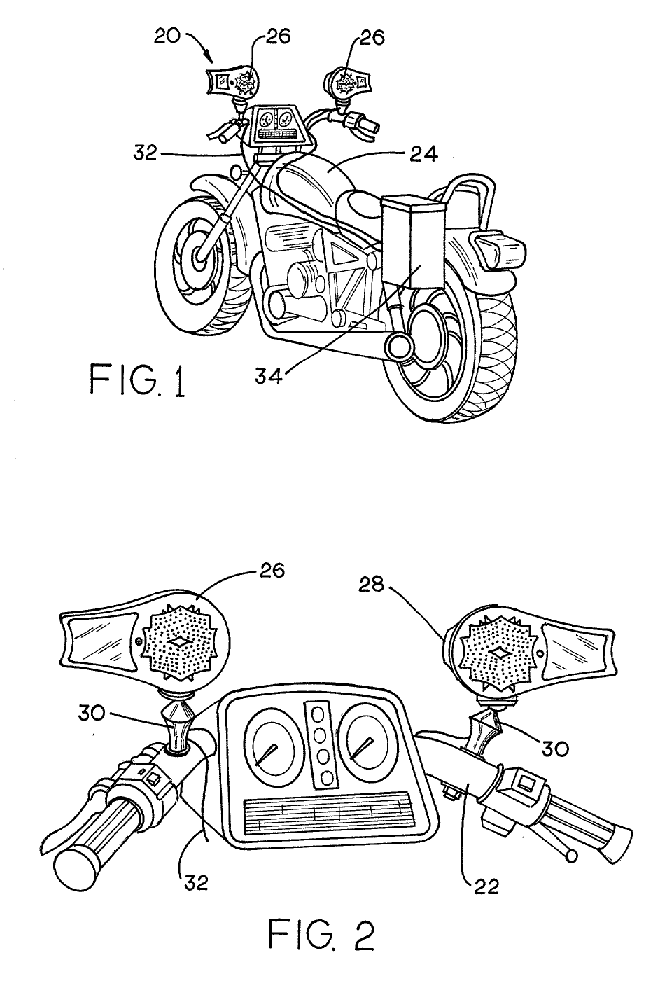

Referring to FIGS. 1 and 2, the combination mirror/speaker system 20 in accordance with this invention is shown mounted on the handlebars 22 of a conventional motorcycle 24. Mirror/speaker system 20 has a two-piece housing 21 consisting of an aft piece 26 and a fore piece 28. Preferably, the mirror/speaker system 20 is composed of metal, and particularly aluminum. Metal is preferred to withstand the torques on the metal connectors necessary to ensure tight and locked positions. Moreover, metal components may be chrome-plated in order to harmonize with other accessories on the high-quality motorcycles. Aluminum is preferred for its weight, castability, and cost. Despite the preference for metal components, it is to be understood that other non-flexible materials, such as hard plastics, are sufficient as housing material.

The mirror/speaker system 20 is mounted on the handlebars 22 through the mounting supports 30.

The mirror/speaker system 20 is in electrical communication by means of electrical wires 32 with an audio system, which audio system is further comprised of a signal generator. The signal generator may be a radio receiver, tape deck player, compact disk player, or other such device. The signal generator may provide recreational sound, but may also be useful for communication systems in emergency vehicles. The signal generator in this embodiment is hidden within the saddlebags 34 for aesthetic and security purposes. In this manner, the saddlebags 34 may be locked when the rider has dismounted and left the motorcycle 24 unattended. Alternatively, the signal generator may be mounted anywhere on the motorcycle 24, including suspended above the console between the handlebars 22 and on the windshield side of the console. In this alternate arrangement, the rider will typically disconnect the signal generator from the mirror/speaker system 20 and take the signal generator with him or her when leaving motorcycle 24 unattended or will otherwise secure it from theft.

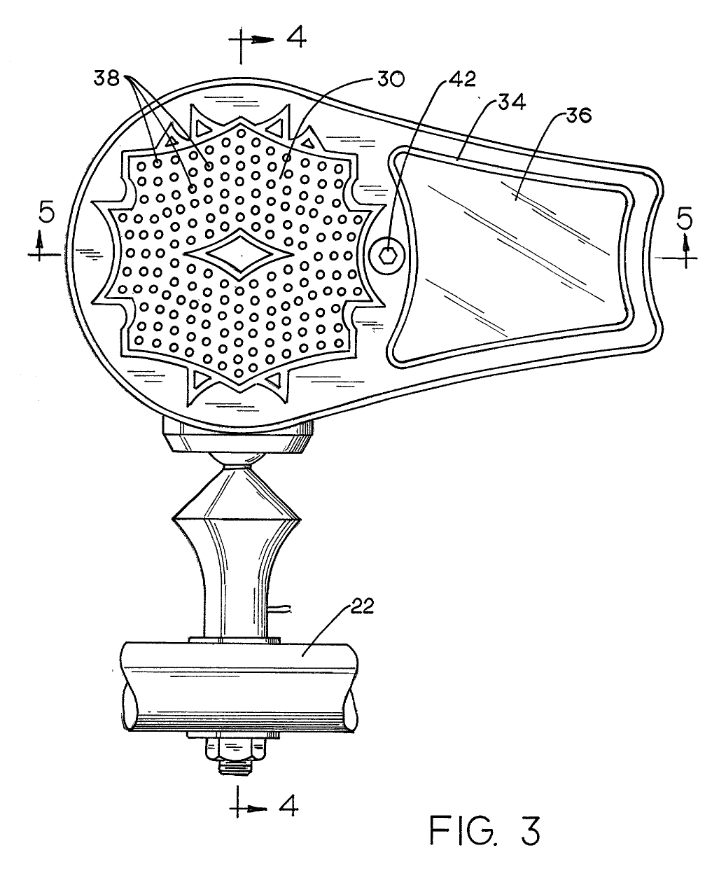

The aft piece 26 of the housing 21 shown in FIG. 3 is substantially plate-like, having a substantially planar vertical aft exterior surface and aft interior surfaces. The rearwardly-facing exterior surface of the aft piece 26 has a sound-releasing area 32 and a recessed mirror-receiving area 34. The mirror-receiving area 34 is most preferably outward of the sound-releasing section 32. In this way, when the sound is produced, it is released from the device at a point nearest to the rider.

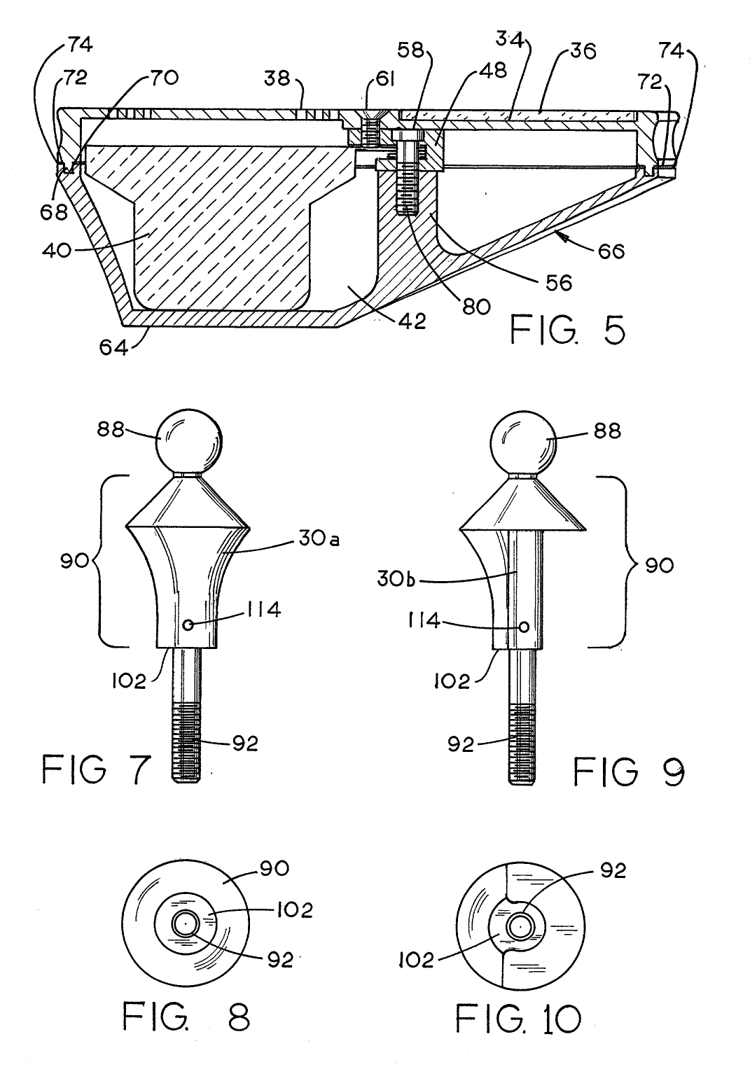

As seen in FIGS. 3 and 5, a glass mirror 36 is affixed in the recessed mirror-receiving area 34. The mirror 36 is attached to the metallic, recessed mirror-receiving portion 34 by well-recognized means such as a styrene-butadiene adhesive, particularly ULTRABOND DC-12060.

The mirror 36 is suitable for rearward view. It may be planar to present an unenhanced image or of a convex surface to allow the rider a wide-angle view of the trailing traffic when the motorcycle 24 is in operation. The orientation of mirror 36 is adjustable for the individual rider by the movement of the housing 21 about the support 30 as will be better seen hereafter.

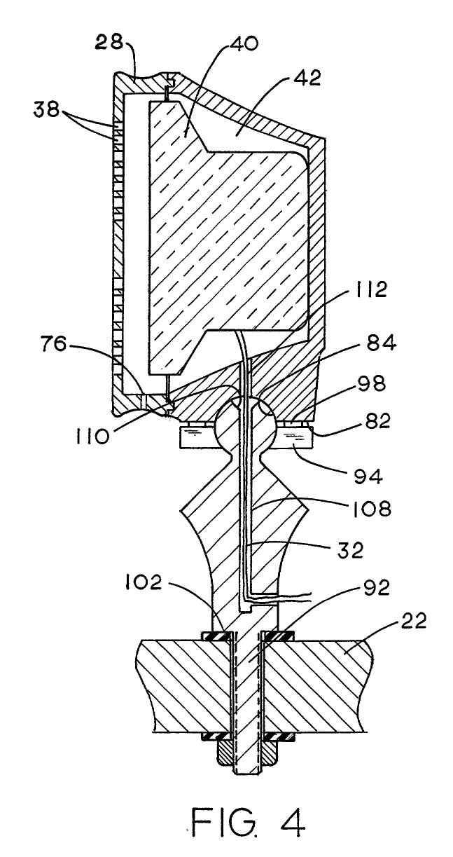

As seen in FIGS. 3 and 4, located in the sound-releasing area 30 of the aft piece 26 is an array of apertures 38. The apertures 38 extend from the exterior through the aft piece 26 into the interior of the housing 21. The exterior area immediately adjacent to each aperture 38 may be raised to further inhibit water infiltration.

Mounted within the interior with respect to the interior surface of the aft piece 26 adjacent to the sound-releasing area 32 is a speaker 40. Speaker 40 is preferably of high-quality with circular sound cone of a rubberized, plasticized, elastomeric, or other water-impervious material. A preferred speaker is Planet Audio brand, model number P3200F or MB Quart brand, model number DKC 108.

The interior surface of the fore piece 28 is asymmetrically concave to create a speaker cavity 42 within the housing 21 when housing 21 is fully assembled, to be more voluminous adjacent to the sound-releasing area to receive speaker components and connections for the radio speaker. The speaker cavity 42 is configured to snugly receive the speaker 40 within such that the circumference of the sound cone 44 is snugly contained. When inserted into the speaker cavity 42, the speaker 40 can rotate but cannot move side-to-side within the speaker cavity 42. The speaker 40 is further secured within the housing 21 by a J-shaped speaker-mount clip 46. The J-shaped speaker-mount clip 46 is horizontally oriented, with the longer leg 48 positioned toward the aft piece 26. Extending through both legs 48, 50 of the clip 46 are aligned clip-securing-screw holes 52. The Planet Audio speaker 40 referenced above is manufactured with two radially-opposite securing tabs 54 for affixing the speaker to a surface. As only one such tab 54 is necessary for proper installation and operation of the speaker 40 within the speaker cavity 42, one of the tabs 54 is removed. When situated within the speaker cavity 42, the speaker 40 is rotated in a manner such that the remaining tab 54 is situated over the spacing column 56 on the interior surface of the fore piece 28 of the housing 21. The clip 46 is slid around the tab 54 such that longer leg 48 and shorter leg 50 straddle clip 46. Clip-securing screw 58 is driven through the threaded clip-securing hole 52 of upper, longer leg 48 of the clip 46, through the tab 54, then through washer 60, thence through the threaded clip-securing hole 52 of lower, shorter left 50 into threaded, snug engagement with the spacing column 56 whereby the speaker 40 is secured from removal out from the speaker cavity 42 and from rotation within the speaker cavity 42 by the clip-securing screw 58. The remainder of the cavity 42 may be filled with sound-baffled material to ensure speaker life.

Fore piece 28 is secured to aft piece 26 by aft-piece securing screw 61 directed through countersunk aft-piece-securing-screw hole 62 and threadedly engaged with aft-piece-securing-screw receiving hole 63 in clip 48. In this way, aft piece 26 may be removed from housing 21 without disengaging any other component.

By attaching the speaker 40 to the fore piece 28, the aft piece 26 may be removed without the speaker 40 falling out of the housing 21.

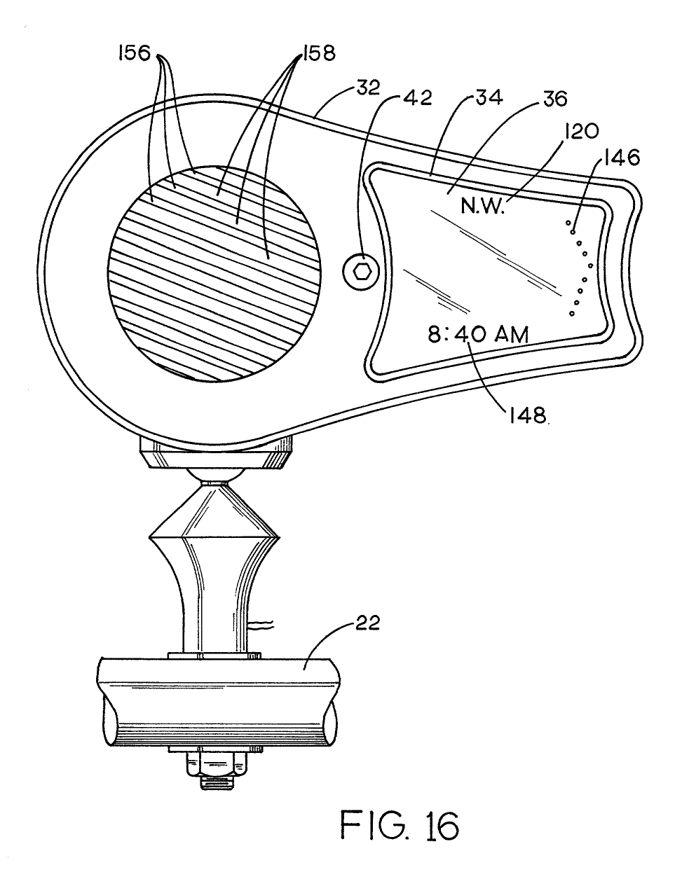

Extending through the aft piece 26 from the exterior of the unit into the interior speaker cavity 42, are a series of regularly spaced apertures 38. The apertures 38 are configured and arranged to allow for release of sound from the speaker 40 located within the housing 21. The apertures 38 shown are small diameter holes (on the order of 1/16″) to minimize rainwater infiltration by taking advantage of the surface tension aspects of the water as it slides down the exterior face of the aft piece 26. Alternatively, louvered grills (seen in FIG. 16) extending downward from the interior to the exterior to direct water away from the speakers 40 may be used. Further, if used, the louvers can extend diagonally from the inside nearest the rider down toward the outside of the motorcycle 24. This latter arrangement allows for a wave guide for the compression sound waves directed toward the rider.

As seen in FIGS. 4 and 5, the fore piece 28 has a fore inner surface and a fore exterior surface. The fore exterior surface is designed to be aerodynamic such that as the motorcycle 24 is operated in a forward motion, air from relative wind created by the forward motion of the motorcycle will strike the leading area of the fore exterior surface and be directed to the side and back of the motorcycle, away from the rider, with the least amount of turbulence. Aerodynamic shape helps resist support 30 loosening by motorcycle 24 motion by reducing wind forces otherwise encountering the mounted unit 20. Additionally, reduction of turbulence experienced from the rear of the unit helps reduce the adverse effects turbulence has on the sound quality as the sound waves leave the unit 20.

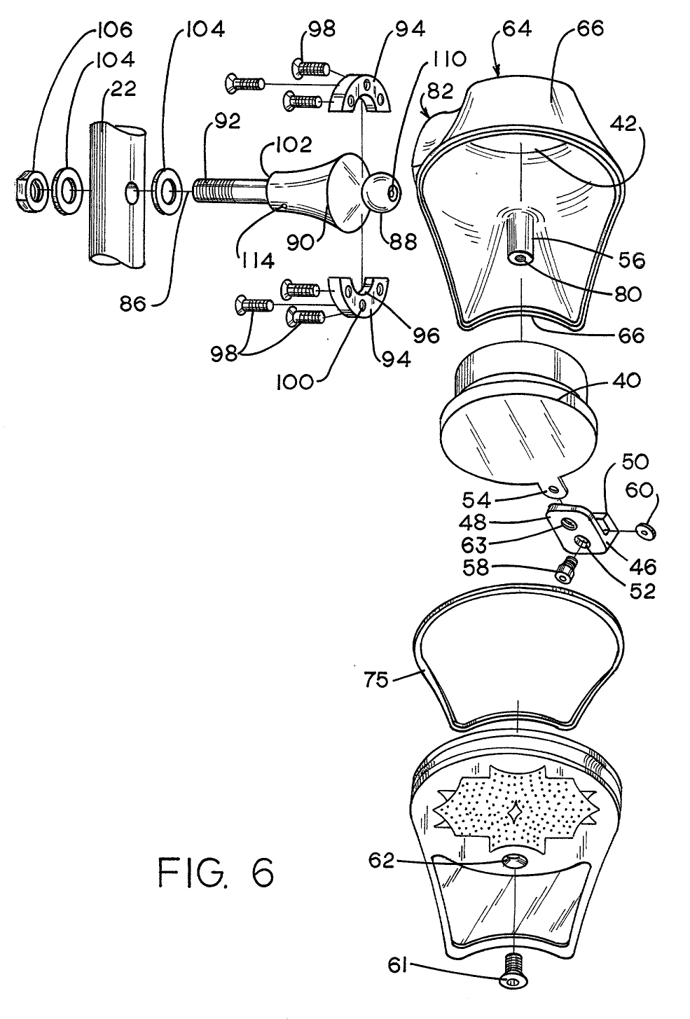

As shown in FIG. 6, the fore exterior surface has an octagonal leading area. This leading area 64 is of small dimension relative to the overall wind-encountering profile of fore surface. Extending from each side of leading area 64 are air guides 66 to deflect the majority of the air striking fore exterior surface away from the rider. Other preferable aerodynamic shapes for fore exterior surface are well known in the industry, including those in horizontal cross-section having an oval or semi-teardrop shape. Similar aerodynamic properties to produce minimal turbulence are also desirable in a vertical cross-section.

It is desirable to maintain dry conditions within the housing 21. In addition to providing a barrier to water infiltration through the apertures 3 8, it is desirable to avoid water movement through the interface between the fore and aft pieces 26, 28. Extending around the entire perimeter of the aft piece 26 is a male ridge 68. Extending around the entire perimeter of the fore piece 28 is a female groove 70 configured to snugly engage the male ridge 68 such that the fore shoulder 72 abuts the aft ledge 74. Not only does the snug fit limit the ability if water to infiltrate, but the arrangement provides a baffle to further inhibit water movement.

To even further maintain a water-repulsive environment within the housing 21 when the fore piece 28 is attached to the aft piece 26, it is possible to position a gasket 75 between at least a substantial portion of the interface between the fore portion and the aft piece 26. The gasket 75 may be of rubber, plastic, a porous polytetrafluoroethylene (PTFE), TEFLON®, GORE-TEX®, silicone, or other durable, flexible, compressible, and water-tight material.

Further, a weep hole 76 is providable at the lowermost point of aft piece 26 to allow any water which does happen into the housing 21 to drain (best seen in FIG. 4).

Extending through the aft piece 26 and into the interior of the housing 21 is at least one housing-screw hole 62, which is countersunk on the exterior surface of the aft piece 26. A fluted, hex-head machine screw 78 is inserted through the hole 77 and into the interior to be secured into a treaded screw-receiving orifice 80 of the spacing column 56. It is desirable to place a rubberized compound within each orifice 80 to resist loosening of the screw 78 from spacing column 56 because of vibration of the operation of the motorcycle 24.

Distending out from the exterior of the bottom of the fore piece 28 is a retention collar platform 82 as depicted in FIGS. 4 and 5. In the center of the retention collar platform 82 is a hemispherical, concave housing pivot port 84.

As seen in FIGS. 4, 6, and 7 through 10, the mounting support 30 provides a means for attaching the housing 21 to the handlebars 22 while allowing for pivotable adjustment of the housing 21 in a manner providing a protected conduit for the speaker wires 32.

As seen in FIG. 6, the mounting support 30 has an axis 86. Attached to the upper end of the mounting support 30 is a spherical ball 88. It has been found that a ball 88 of 0.7650 of an inch diameter provides a satisfactory balance between strength and useful motion of the pivot. The ball diameter is larger than the diameter of the hemispherical diameter of the housing pivot port 84; it has been found that a 0.0150 of an inch differential is beneficial at these dimensions. The ball 88 is integrally attached to the upright post portion 90. Upright post portion 90 is cylindrically tapered away from the ball 88 to present a cone below the ball 88. It has been found that a 45° taper allows for sufficient operating range of the pivot of the housing 21 about the ball 88. Extending down from the upright post portion 90 is a threaded lower connecting portion 92.

A left side mounting support 30a is pictured in FIGS. 7 and 9. For aesthetic purposes, the support 30a is symmetric about its longitudinal axis 86. With smooth lines and curves, this design will decrease wind resistence. The right side support 30b shown in FIGS. 8 and 10 lacks the symmetry of its left side counterpart 30a. A longitudinal indentation along the upright post portion 90 of the right side support 30a is designed to accommodate the brake-fluid reservoir typically mounted on the right handlebar. Nevertheless, the design differences between the right and left side supports 30b, 30a, do not result in different attachment means of the support 30 to either the housing 21 or the handlebar.

The ball 88 is secured to the housing 21 into the housing pivot port 84 by two C-shaped retention-collar segments 94 as seen in FIGS. 4 and 6. Each retention-collar segment 94 has an inner edge 96 which is beveled in a manner that the bevel will be able to provide a seat for the ball 88. Together the two retention collar segments 94 form a complementary shape as the retention collar platform 82. For purposes of illustration, the platform 82 and collar segments 94 depicted are circular.

The retention collar segments 94 are each attached to the retention-collar platform 82 by three short collar bolts 98 screwed up through the collar orifices 100 into threaded engagement with the retention collar platform 82. The ball 88 is retained between the retention collar segments 94 and the retention collar platform 82 in a manner such that the ball 88 is in frictional contact with both the retention collar 94 and the platform 82 allowing for positionable adjustment of the housing 21 unit about the ball 88.

Bottom shoulder 102 of upright post portion 90 is configured to conform to the shape of the handlebar 22 to which it will be attached. The threaded lower connecting portion 92, which is narrower than upright mounting post portion 90, extends into and through a hole drilled through the handlebar 22. Between the handlebar 22 and the bottom shoulder of upright mounting post portion 102 is a TEFLON® washer 104 to reduce the tendency to dislodge from the handlebar 22 due to vibration of motorcycle operation. A threaded nut 106 is screwed onto the threaded lower portion 92 for locking engagement with the handlebar 22. For similar anti-vibration purposes, a TEFLON® washer 104 is placed between the nut 106 and the underside of the handlebar 22.

Extending axially through the support 30 is a wire conduit 108. The upper end of the conduit 108 expands into a funnel-shaped upper entry port 110. The funnel shape facilitates movement of wires 32 extending from the speaker 30 through a platform outlet 112 thence through the conduit 108 without binding as the housing 21 is pivoted about the ball 88. Wire 30 extends through the conduit 108 thence out of the lower exit port 114 at a point above the handlebar 22.

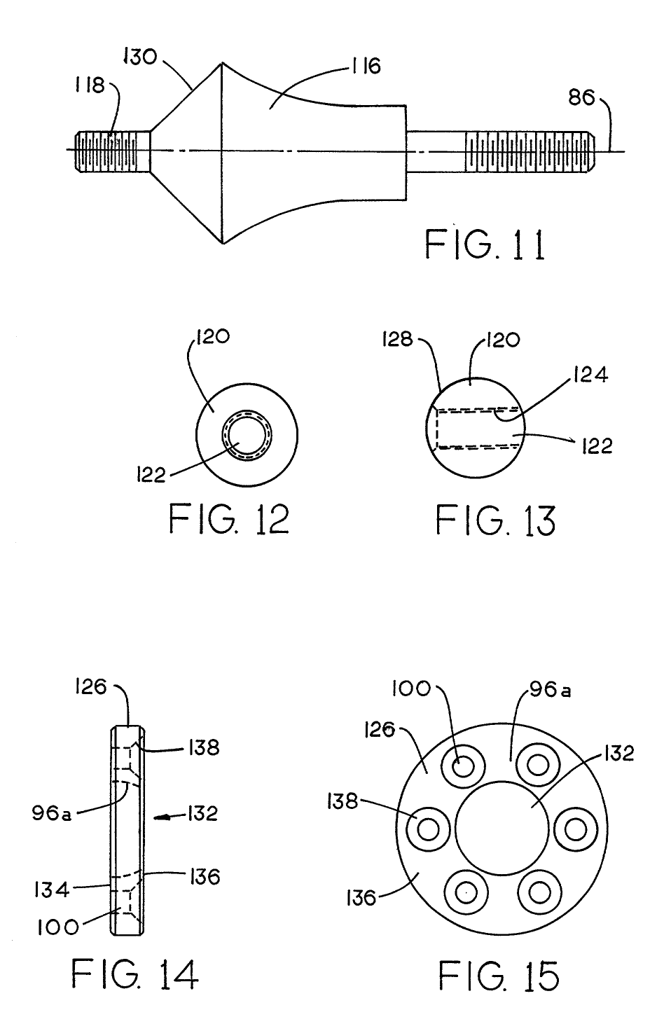

FIGS. 11 through 15 show an alternate mounting post assembly. Alternate mounting post 116 shown is a mounting post for mounting housing 21 on the handlebar 22 on left side of the motorcycle 24. It should be clear as seen earlier, that alternative mounting post for installation on the right side of motorcycle 24 may have a body similar to that depicted in FIGS. 9 and 10.

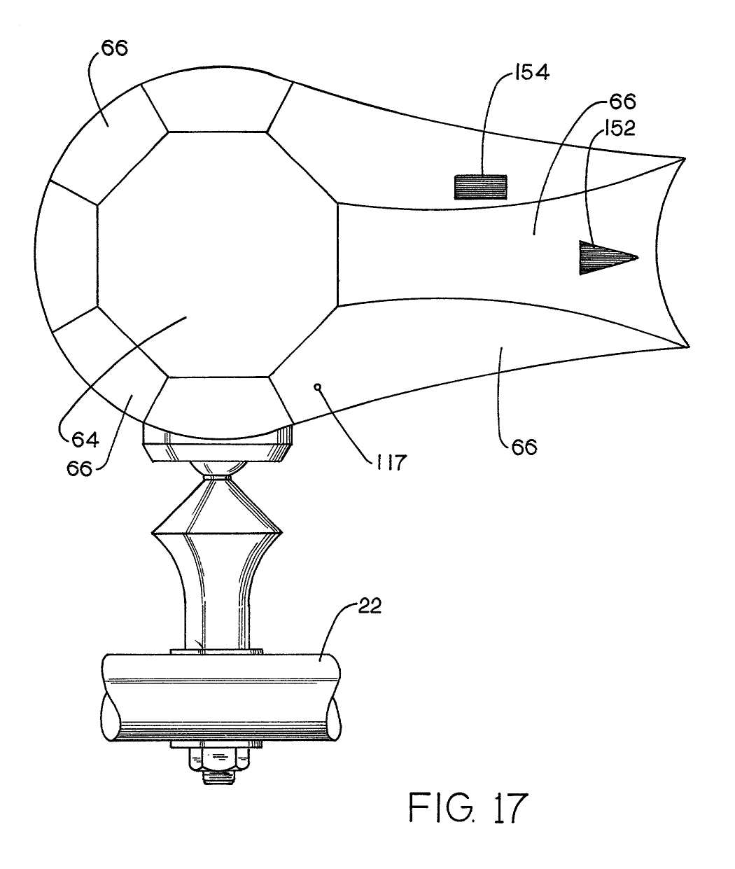

As shown, mounting post 116 has a solid core. When a solid core mounting post 116 is used, wires 32 will leave housing 21 through alternative wire releasing aperture 117 (shown in FIG. 17). Solid core makes the mounting post 116 stronger.

Alternative mounting post 116 has a cylindrical, threaded ball-integrating member 118. Ball 120 has a complementary post-integrating channel 122 with tapped side walls 124. Threaded ball-integrating member 118 and tapped side walls 124 are configured to be able to enter into snug, threaded engagement with small tolerances.

Prior to attaching ball 120 to threaded ball-integrating member 118, a retention ring 126 is positioned between the outer surface 128 of the ball 120 and the upper surface 130 of mounting post 116. Retention ring 126 is mounted on mounting post 116 as ball-integrating member 118 extends through hole 132. Retention ring 126 is mounted such that top surface 134 is adjacent to outer surface 128 and bottom surface 136 is adjacent to upper surface 130 of mounting post 116.

Retention ring 126 is locked in location by ball 120. Ball 120 is attached in integrated, threaded engagement with threaded ball-integrating member 118. Integration occurs through the use of LOCTITE® primer (#7649) and bond (#271) on both threaded components 118, 124.

The interior surface 96a of retention ring 126 is contoured to match the outer surface 128 of the ball 120 thereby creating a seat for the ball 120 (as shown in FIG. 14 and in phantom in FIG. 15).

A chamfered countersink surface 138 is provided at the bottom surface 136 of the retention ring 126 at the head of six collar orifices 100 to allow for flush screw-head installation when the retention ring 126 is attached to retention-collar platform 82 by six flathead screws 98 in the manner discussed above with C-shaped retention-collar segments 94.

FIGS. 16 and 17 show other embodiments of the invention. FIG. 16 shows the front view of the rear view mirror 36 on a right side device 20. A rear-facing right-turn-indicating signal 146 composed of an array of dots is incorporated within the mirror 36. The rear-facing right-turn-indicating signal 146 is in communication with the turn-signal generator (not shown) which comes as standard equipment on the motorcycle 24. A similar rear-facing turn-indicating signal is incorporated into the left side mirror 36. This technology is known within the industry and is seen in example in MUTH brand Kit #200-0077-0 for Harley-Davidson motorcycles. In a like manner, the time and motorcycle orientation 148, 150 may be digitally displayed within the mirror surface by light-emitting diodes placed between a non-silvered portion of the mirror 36 and the mirror-receiving area 34 from data produced in commercially available products located within the cavity 42 adjacent to the mirror-receiving portion of the aft piece 26. Alternatively, the signal-indicator 146 and/or the time and direction graphics 148, 150 may be positioned on the exterior of the aft piece 26 other than on the mirror 36.

An on-coming-traffic turn-indicating signal 152 and a stop-indicating signal 154 are shown in FIG. 17. These signals are visible to oncoming traffic when the motorcycle 24 is in operation. These signals 152, 154 are in communication with the turn and stop signal generators already installed on the motorcycle 24. When used in conjunction with the rear-facing turn-indicating signal 146, one set of wires from the signal generator to the device 20 is sufficient to convey the indication to both the rear-facing turn-indicating signal 146 and the on-coming-traffic turn-indicating signal 152.

Also shown in FIG. 16 is an alternate embodiment of the of the sound-releasing area 32. In this embodiment, louvered grills 156 separate sound slots 158 which are in sound communication with the speaker 40. The grills 156 are angled down from the side of the device 20 nearest the operator to the outside of the motorcycle 24. In this way, water may be channeled away from the speaker. Grills 156 may also be louvered downward from fore-to-aft to further protect speaker 40. Alternatively, grills 156 may be otherwise advantageously angled fore-to-aft to reflect sound toward the operator thereby enhancing the sound delivery to the operator from the speaker 40.

While the principles of the invention have been shown and described in connection with but a few embodiments, it is to be understood clearly that such embodiments are by way of example and are not limiting.

1. A mirror-speaker combination for mounting on a motorcycle comprising:
an aft portion having a concave interior surface;
a fore portion having an exterior surface with a mirror-receiving section of said exterior surface suitable to accommodate a mirror and with a sound-releasing section of said exterior surface defining at least one sound-releasing aperture therethrough, and with an interior surface, said fore portion releasably, sealably attached with respect to the aft portion thereby presenting a housing;
a mirror attached with respect to the exterior surface of the fore portion whereby a motorcycle operator is able to view objects rearwardly while on the motorcycle;
a speaker attached with respect to the interior surface of the fore portion whereby sound produced by the speaker may exit the housing through the at least one sound-releasing aperture; and
a mounting assembly attached with respect to the housing whereby the mirror-speaker combination may be attached with respect to a handlebar of the motorcycle.

2. The mirror-speaker combination of claim 1 further comprising a sealing element placed between the fore portion and the aft portion of the housing when the portions are attached, thereby making the housing watertight.

3. The mirror-speaker combination of claim 2 wherein the sealing element is of a porous polytetrafluoroethylene (PTFE).

4. The mirror-speaker combination of claim 1 further comprising:
a signal source attached to the motorcycle remote from the housing, with signal-transmitting wires extending therefrom;
a wire-receiving section of the housing defining a port therethrough whereby the wires may pass into the interior of the housing into electric communication with the speaker.

5. The mirror-speaker combination of claim 4 wherein the mounting assembly contains a distal end attached to the housing and a proximal end, and further contains a wire-transmitting conduit with a first opening at the distal end of the mounting assembly and a second opening dispensed relative to the proximal end; and wherein the distal end of the mounting assembly is attached to the housing at the port whereby the wires enter the port of the housing through the conduit.

6. The mirror-speaker combination of claim 1 wherein the at least one sound-releasing aperture is configured and arranged to deflect rainwater away from the speaker.

7. The mirror-speaker combination of claim 1 wherein the aft portion further has at least one light-emitting element, configured and arranged to be visible downrange when the motorcycle is in operation.

8. The mirror-speaker combination of claim 7 wherein the at least one light-emitting element is selectively employable by a motorcycle operator to provide a visual indicator signal to on-coming traffic as to the motorcycle operator's operational intent.

9. The mirror-speaker combination of claim 1 wherein the mounting assembly is comprised of:
a substantially spherical upper-portion joint end; and
a substantially cylindrical lower portion attached with respect to the upper-portion joint end, having a connecting end suitable for releasable attachment to the motorcycle handlebars.

10. In an audio system for motorcycles, a mirror/speaker system comprised of a mirror/speaker housing with a substantially vertical fore member removably attached to an aft member, and both a speaker and a mirror supported by said fore member, said housing mounted on a handlebar of the motorcycle by a mounting assembly, said audio system further comprising a power amplifier and an audio-selection unit attached with respect to the motorcycle remote from the housing, connected through said power amplifier to said speaker, wherein said fore member includes said speaker supported by said fore member in a position within said housing, said fore member defining at least one aperture in a speaker-receiving section of the fore member adjacent to said speaker, and wherein said mirror is mounted to an exterior surface of said fore member on a mirror-receiving section, configured and arranged so that the mirror does not impinge on the at least one aperture.

11. The combination of claim 10 further comprising a sealing element between the fore member and the aft member.

12. The combination of claim 11 further comprising two mirror/speaker assemblies mounted on handlebars on each side of the motorcycle.
